(19) United States
(12) Patent Application Publication
(10) Pub. No.: US 2015/0350656 A1
(43) Pub. Date: Dec. 3, 2015

(54) DYNAMIC VIDEO CORE CLOCK AND VOLTAGE SCALING

(71) Applicant: Qualcomm Innovation Center, Inc., San Diego, CA (US)

(72) Inventors: Hyukjune Chung, San Diego, CA (US); Scott Yee, San Diego, CA (US)

(21) Appl. No.: 14/724,575

(22) Filed: May 28, 2015

Related U.S. Application Data
(60) Provisional application No. 62/005,756, filed on May 30, 2014.
(60) Provisional application No. 62/066,212, filed on Oct. 20, 2014.

(51) Int. Cl. H04N 19/152; H04N 19/115; H04N 19/44

(52) U.S. Cl. CPC H04N 19/152; H04N 19/44; H04N 19/115

(57) ABSTRACT

Disclosed are systems and methods for dynamically scaling a clock and/or voltage of a video core. The method may include buffering video frames in an input buffer queue and encoding the video frames from the input buffer queue with a video encoder to generate encoded video frames. An input buffer queue is monitored to generate an indication of a fullness of the buffer queue and a high input-threshold level is established for the input buffer queue and a low input-threshold level for the input buffer queue. A clock frequency of the video encoder is increased in response to the indication of the fullness reaching the high input-threshold for the buffer queue and the clock frequency of the video decoder is decreased in response to the indication of the fullness reaching the low input-threshold for the buffer queue.

### CLAIM OF PRIORITY UNDER 35 U.S.C. §119

The present Application for Patent claims priority to Provisional Application No. 62/005,756 entitled “DYNAMIC VIDEO CORE CLOCK AND VOLTAGE SCALING” filed May 30, 2014 and Provisional Application No. 62/066,212 entitled “VIDEO CORE DYNAMIC CLOCK AND VOLTAGE SCALING FOR VIDEO ENCODING” both of which are assigned to the assignee hereof and hereby expressly incorporated by reference herein.

### BACKGROUND

I. Field of the Disclosure

The technology of the disclosure relates generally to video frame encoding and decoding, and more particularly to the scaling of the clock and/or voltage of a video core.

II. Background

Video frame encoding time varies depending on scene types and frame complexities. In addition, the frame source schedule may vary depending on system resources, light conditions for camera system, etc. An input buffer plays role of smoothing out input jitter from the frame source and encoding time variations. Because the clock frequency and supply voltage associated with a video encoder may be designed to handle the worst case encoding complexity, the power demanded by the encoder may be unnecessarily high.

Similarly, video frame decoding complexity varies depending on frame types, prediction modes, and scene types, etc. Because the clock frequency and supply voltage associated with a video decoder are designed to handle the worst case decoding complexity, frame-by-frame decoding time can vary significantly. The clock and voltage of a video decoder have been varied based upon complex algorithms that attempt to predict frame complexities. But predicting frame complexities based on prior history is quite difficult because frame complexity can vary significantly, and scaling clock frequency or voltage too frequently may lead to instability of the decoder.

### SUMMARY

An aspect may be characterized as a method for controlling a video core. The method may include buffering video frames in an input buffer queue, encoding the video frames with a video encoder to generate encoded video frames, and monitoring the input buffer queue to generate an indication of a fullness of the input buffer queue. A high-input threshold for the input buffer queue and a low-input threshold level are established for the input buffer queue, and a clock frequency of the video encoder is increased in response to the indication of the fullness reaching the high-input threshold for the input buffer queue and the clock frequency of the video encoder is decreased in response to the indication of the fullness reaching the low-input threshold for the input buffer queue.

The method may also include decoding encoded video frames with a video decoder to generate decoded video frames, buffering the decoded video frames in an output buffer queue, monitoring the output buffer queue to generate an indication of a fullness of the output buffer queue, and establishing a high-output threshold for the output buffer queue and a low-output threshold for the output buffer queue. A clock frequency of the video decoder may be decreased in response to the indication of the fullness reaching the high-output threshold for the output buffer queue and the clock frequency of the video decoder may be increased in response to the indication of the fullness reaching the low-output threshold for the output buffer queue.

Another aspect may be characterized as a computing device that includes a video decoder to generate decoded video frames from encoded video frames, a clock frequency controller to control a clock frequency of the video decoder, a voltage controller to control a voltage of the video decoder, and an output buffer queue to buffer the decoded video frames. The computing device also includes an output buffer queue monitor to monitor the output buffer queue and generate an indication of a fullness of the output buffer queue and a dynamic clock and voltage scaling component to receive the indication of the fullness of the output buffer queue and provide control signals to the clock frequency controller to effectuate changes to the clock frequency based upon a fullness of the output buffer queue.

The computing device may also include an input buffer queue to buffer video frames from a frame source, a video encoder to generate encoded video frames from the video frames, a clock frequency controller to control a clock frequency of the video encoder, and an input buffer queue to monitor the input buffer queue and generate an indication of a fullness of the input buffer queue. The dynamic clock and voltage scaling component is configured to receive the indication of the fullness of the input buffer queue and provides control signals to the clock frequency controller to effectuate changes to the clock frequency based upon a fullness of the input buffer queue.

### BRIEF DESCRIPTION OF THE DRAWINGS

FIG. 1 is a block diagram depicting aspects of a video processing system;

FIG. 2 is a block diagram depicting an encoding portion of the system depicted in FIG. 1;

FIG. 3 is a block diagram depicting thresholds of the input buffer of FIG. 2;

FIG. 4 is a graph illustrating an example of input frame buffers over time in a mode of operation;

FIG. 5 is a flowchart depicting a method that may be carried out in connection with embodiments disclosed herein;

FIG. 6 is a graph illustrating an example of input frame buffers over time in another mode of operation;

FIG. 7 is a block diagram depicting a decoding portion of the system depicted in FIG. 1;

FIG. 8 is a block diagram depicting thresholds of the output buffer of FIG. 7;

FIG. 9 is a graph illustrating an example of output frame buffers over time in a mode of operation;

FIG. 10 is a flowchart depicting a method that may be carried out in connection with embodiments disclosed herein;

FIG. 11 is a graph illustrating an example of output frame buffers over time in another mode of operation; and

FIG. 12 is a block diagram depicting physical components that may be utilized in connection with embodiments disclosed herein.

### DETAILED DESCRIPTION

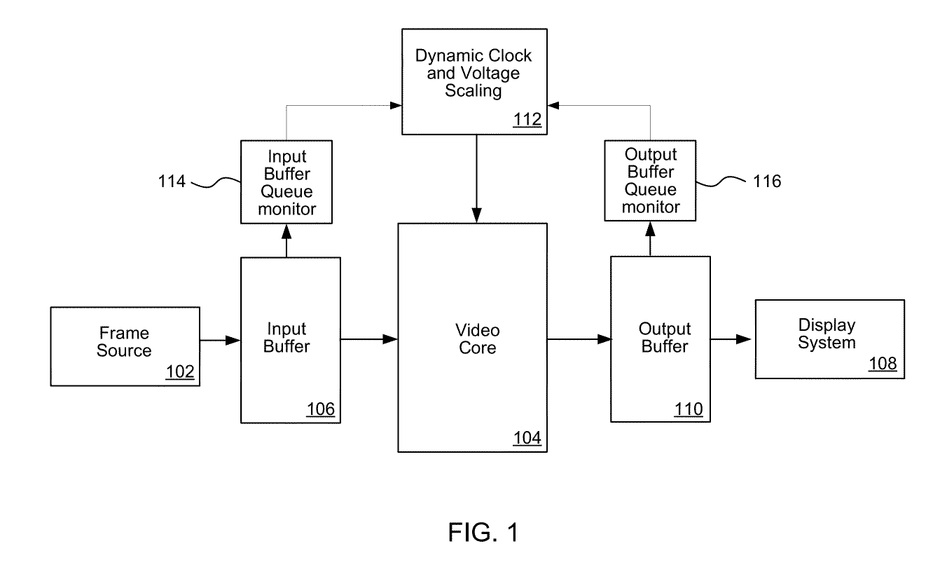

Referring to FIG. 1, it is a block diagram depicting aspects of a video processing system. The depicted system may be realized in computing devices such as smart phones, tablets, netbooks, set top boxes, entertainment units, navigation devices, and personal digital assistants, etc. As shown, a frame source 102 is coupled to a video core 104 via an input buffer 106, and a display system 108 is coupled to the video core 104 via an output buffer 110. In addition, a dynamic clock and voltage scaling (DCVS) component 112 is coupled to the video core 104, an input buffer queue monitor 114 is coupled to the DCVS component 112 and the input buffer 106, and an output buffer queue monitor 116 is coupled to the DCVS component 112 and the output buffer 110.

It should be recognized that the depiction of components in FIG. 1 is a logical depiction and is not intended to depict discrete software or hardware components, and in addition, the depicted components in some instances may be separated or combined. For example, the DCVS component 112 may be adapted to provide the functionality provided by the buffer queue monitors 114, 116 so that the DCVS component 112 both monitors the buffer queues and sends control signals to a clock controller and/or voltage controller discussed further herein. When implemented, the depicted components may be realized by hardware, firmware, and/or hardware in connection with software. For example, the video core 104 may be realized by a hardware codec (e.g., a field programmable gate array (FPGA)), a digital signal processor (DSP) codec, or software codec (e.g., an application processor in connection with processor-executable instructions). As a consequence, the clock frequency and or voltages that are controlled may be associated with hardware clocks, a DSP clock, and/or an application processor clock. One of ordinary skill in the art will also appreciate that there are many components that are not depicted FIG. 1 for simplicity.

In general, embodiments disclosed herein scale the clock of the video core (also referred to as a video engine) by monitoring an input buffer queue of the input buffer 106 and/or an output buffer queue of the output buffer 110. With respect to encoding operations, when there is sufficient room in the input buffer queue for video frames arriving from the frame source 102, then the video core 104 may slow down a rate at which frame data is drained from the input buffer 106, and when there is not sufficient space to store frame data (from the frame source 102) in the input buffer 106, then the clock of the video core may be increased to drain frame data faster from the input buffer queue. Depending on the use case, the frame source 102 may be a camera system (e.g., in a camcorder use case), video decoder engine (e.g., in a transcoding or Miracast use case), or graphic contents (e.g., in a Miracast use case).

In connection with decoding operations, as long as there are a sufficient number of frames buffered in the output buffer 110 between the video core 104 and the display system 108 (e.g., so that the display system 108 may continuously display the frames), a video decoder of the video core 104 may slow down. As a consequence, embodiments described herein increase the clock frequency of the video core 104 when the output buffer queue is low, and decrease the clock frequency of the video core 104 when the output buffer 110 is full. As those of ordinary skill in the art will appreciate, the display system 108 may include a variety of components known in the art for processing and presenting (e.g., via a display, such as a touch screen display) decoded media data to a user of a computing device.

As discussed further herein, the DCVS component 112 provides one or more outputs to a clock controller and/or voltage controller of the video core 104, which prompt the clock controller and/or the voltage controller to adjust a clock frequency and/or voltage of the video core 104, respectively. With respect to the adjustment of the voltage, it should be recognized that the voltage adjustment may be applicable to a collection of components that includes the video core. In other words, the adjustments to the voltage level discussed herein may apply to a larger voltage domain (including several components), which the video core is a part of.

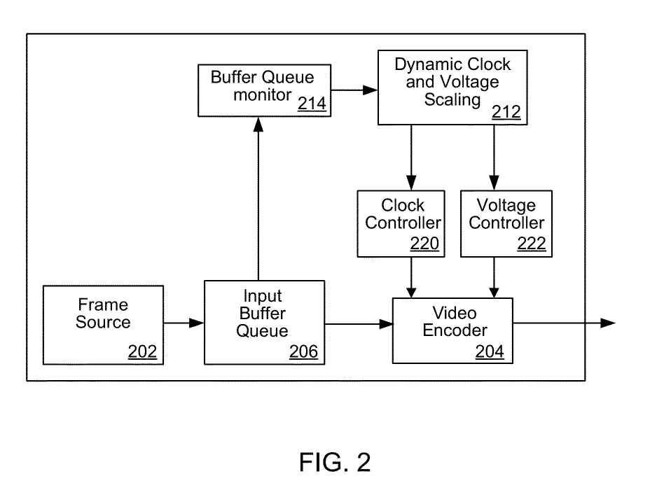

Referring to FIG. 2, shown is a block diagram depicting an encoding portion of the system depicted in FIG. 1. As depicted, an input buffer queue 206 is disposed between a frame source 202 and a video encoder 204. In addition, a buffer queue monitor 214 is disposed to monitor the input buffer queue 206 and communicate information to a dynamic clock and voltage-scaling (DCVS) component 212. As shown, both a clock controller 220 and a voltage controller 222 are disposed between the DCVS component 212 and the video encoder 204.

It should be recognized that the depiction of components in FIG. 2 is also a logical depiction and is not intended to necessarily depict discrete software or hardware components, and in addition, the depicted components in some instances may be separated or combined. For example, the DCVS component 212 may be adapted to provide the functionality provided by the buffer queue monitor 214 so that the DCVS component 212 both monitors the input buffer queue 206 and sends control signals to the clock controller 220 and voltage controller 222. When implemented, the depicted components may be realized by hardware, firmware, and/or hardware in connection with software. For example, the video encoder may be realized by a hardware encoder (e.g., a field programmable gate array (FPGA)), a digital signal processor (DSP) encoder, or software encoder (e.g., an application processor in connection with processor-executable instructions). As a consequence, the clock frequency and or voltages that are controlled may be associated with hardware clocks, a DSP clock, and/or an application processor clock. One of ordinary skill in the art will also appreciate that there are many components that are not depicted FIG. 2 for simplicity. For example, the depicted clock controller 220 and voltage controller 222 drive a clock network (not shown) and regulators (not shown) that drive the clock frequency and voltage for the video encoder 204. In addition, the DCVS component 212 may be realized by non-transitory processor executable instructions that are executed by a processor to effectuate the functions described herein.

In general, embodiments disclosed herein scale the clock and voltage of the video encoder by monitoring the buffer fullness of the input buffer queue. In general, when there is enough room in the input buffer queue, then the video engine may slow down a rate at which frame data is drained from the input buffer queue, and when there is not enough space to store frame data (from the frame source) in the input buffer queue, then the clock and voltage of the video engine may be increased to drain frame data faster from the input buffer queue.

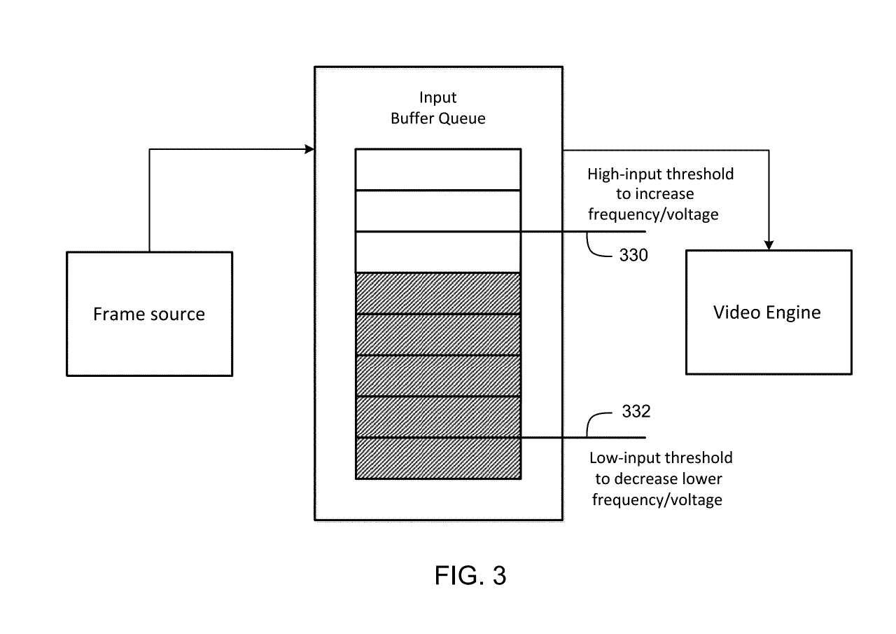

In the embodiment depicted in FIG. 2, a buffer queue monitor 214 observes the input buffer fullness and provides (to the DCVS component 212) an indication of how full the input buffer queue 206 is. As depicted, the DCVS component 212 operates to control the clock controller 220 and voltage controller 222 to adjust the clock frequency (and/or supply voltage) accordingly. More specifically, the clock frequency (and/or supply voltage) may be lowered if buffer fullness hits a low-input threshold 332, and switches to higher clock frequency (and/or supply voltage) if buffer fullness hits a high-input threshold 330 as shown in FIG. 3, which depicts thresholds 330, 332 in an exemplary input buffer queue. In general, when the input buffer fullness is low, then a clock of the video encoder 204 can be slowed down to reduce the drain rate from the input buffer queue 206. When the buffer fullness is high, then the performance of the video encoder 204 needs to be increased to increase the drain rate from the input buffer queue 206 in order to give sufficient space for the frame source 202 to store data in the input buffer.

Beneficially, methodologies for controlling the clock and voltage of the video core (as disclosed herein) are reliable because they do not rely on performance assumptions or predictions about the complexity of the video frames. Instead, the input buffer queue 206 is monitored to avoid buffer overflow.

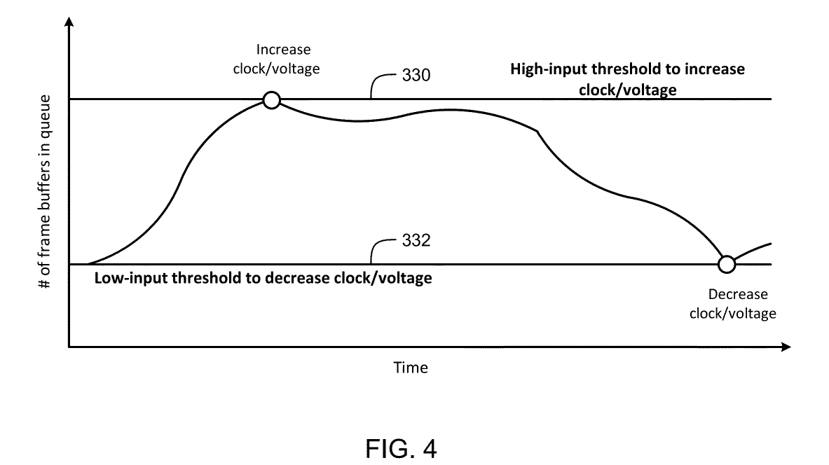

The high and low input thresholds 330, 332 may be set in a static way or an adaptive way. An example of static thresholds is shown in FIG. 4. As shown, the clock frequency and/or voltage of the video encoder 204 is set to low a setting until a number of frames queued hits the high-input threshold 330, then frequency and/or voltage is increased because the video processing system needs to encode more frames per second to provide space in the input buffer queue 206 by draining frames faster. And when the number of frames queued hits the low-input threshold, then clock frequency and/or voltage of the video encoder 204 is decreased.

Although the method depicted in FIG. 4 provides a clear example of how buffer fullness may be used as a basis for adjusting the video encoder 204, multiple buffer threshold levels may be utilized and the buffer threshold levels may be dynamically modified.

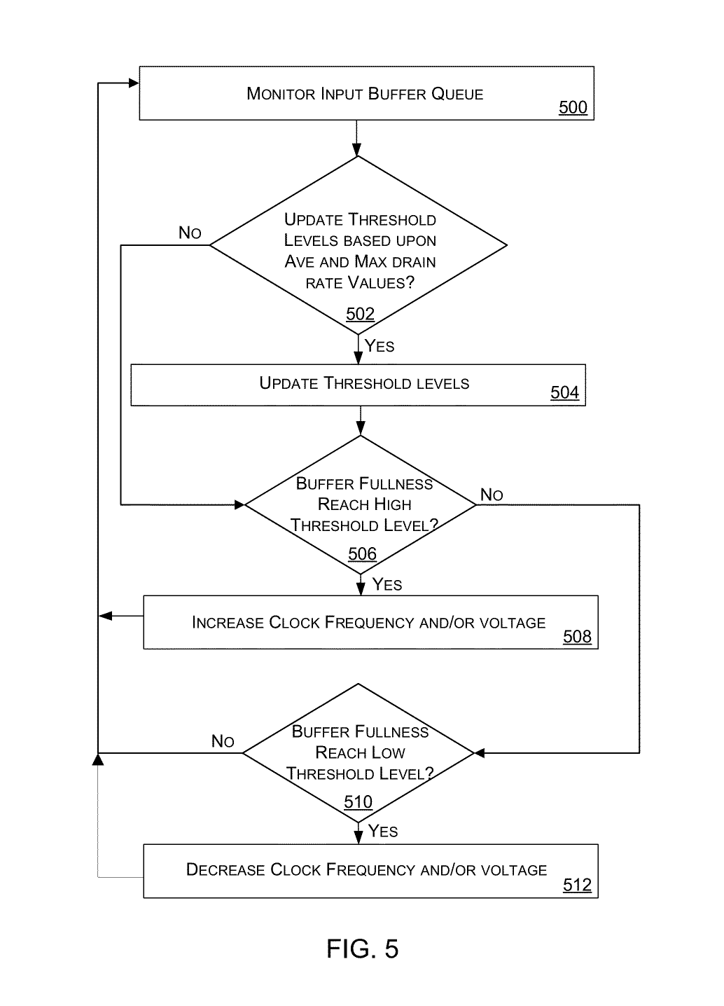

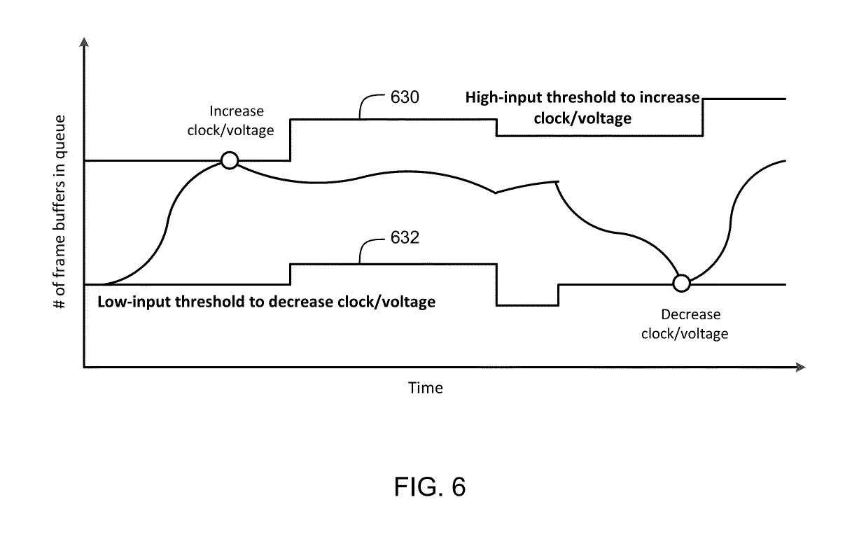

Referring to FIG. 5 for example, shown is a flowchart depicting a method that may utilize dynamic input-threshold levels. While referring to FIG. 5, reference is also made to FIG. 6, which is a graph depicting a number of frame buffers in the input buffer queue 206 versus time relative to dynamic input-thresholds. As shown, the buffer queue monitor 214 monitors the input buffer queue 206 (e.g., on an ongoing basis) (Block 500), and if input-threshold levels 630, 632 should be updated (Block 502), the input-threshold levels 630, 632 may be adaptively calculated and then updated by the DCVS component 212 (Block 504).

More specifically, one way to adapt the input-threshold levels is by utilizing the buffer drain rate of the input buffer 106. The buffer drain rate is affected by the frame-complexity variation of a sequence, but frame complexity is not the only factor affecting the buffer fullness or drain rates. There may be other factors in the system that impact the buffer fullness, or slow down/speed up the drain rate.

For example, a low-input threshold level 632 (input-threshold_{low}) may be set as a function of the average buffer drain rate and maximum buffer drain rate:

input-threshold_{low}=f(avg_buffer_drain_rate,max_buffer_drain _rate)

Setting the low-input threshold 632 as a function of the average buffer drain rate and maximum buffer drain rate effectively sets the low-input threshold 632 to a level to avoid frequent fluctuations to the clock frequency and/or the voltage of the video encoder 204. Although not required, the low-input threshold 632 may be generally defined as input-threshold_{low} =α*ave_buffer_drain_rate+β*max_buffer_drain_rate+λ where α and β may be tuning parameters that may be adjusted based upon observation of the effect of the clock and/or voltage scaling under the low-input threshold 632, and λ may be a tuning parameter that may be determined for system performance or stability requirements.

In contrast, the high-input threshold 630 functions as a threshold to allow the number of available frame buffers (in the input buffer queue 206) to catch up to the rate that the frame source 202 provides the frames; thus the high-input threshold 630 (input-threshold_{high}) may be set as a function of the maximum buffer drain rate:

input-threshold_{high}=f(max_buffer_drain_rate)

In this way, if the DCVS component 212 observes a higher peak drain rate, then the high-input threshold 630 may be set higher to have enough of a safeguard so that there is sufficient space to accommodate all frames as they are received from the frame source 202. The high-input threshold 630 may generally be defined as input-threshold_{high}=δ*max_drain_rate+γ where δ may be tuning parameter that may be adjusted based upon observation of the effect of the clock and/or voltage scaling under the high-input threshold 630, and γ may be derived from system requirements. For example, γ may be a function of the minimum number of frame buffers that the frame source 202 needs to continue to send frames to the input buffer queue 206.

As depicted in FIG. 5, once the input threshold levels 630, 632 are updated (Block 504), if the input buffer fullness reaches the high-input threshold 630, the DCVS component 212 operates to increase the clock frequency and/or voltage of the video decoder (Block 508); thus enabling the encoder 204 to process (e.g., encode) more frames per second. As shown, if a fullness of the input buffer 106 reaches the low-input threshold, the DCVS component decreases the clock frequency and/or voltage of the video decoder (Block 512); thus reducing power drawn by the video encoder 204. As depicted in FIG. 6, repetitively traversing the loop depicted in FIG. 5 over time effectuates a dynamic updating to the high-input threshold 630 and the low-input threshold 632.

FIGS. 5 and 6 describe a specific example in which two input threshold levels 630, 632 are used to form a single bounded region between the threshold levels, but in general, there may be more than two input threshold levels 630, 632 so that there are multiple bounded regions wherein each bounded region is defined by a corresponding group of two of the multiple input threshold levels. In addition, it is also possible that a low threshold for a group may be the same as a high threshold in the next consecutive group. More specifically, when there are three voltage operating points, V0, V1, V2 (where V0<V1<V2), between V0 and V1, two thresholds may be (input_threshold_low_{—}0, input_threshold_high_{—}0), and between V1 and V2, two thresholds may be (input_threshold_low_{—}1, input_threshold_high_{—}1), and in addition, it is possible that input_threshold_high_{—}0=input_threshold_low_{—}1.

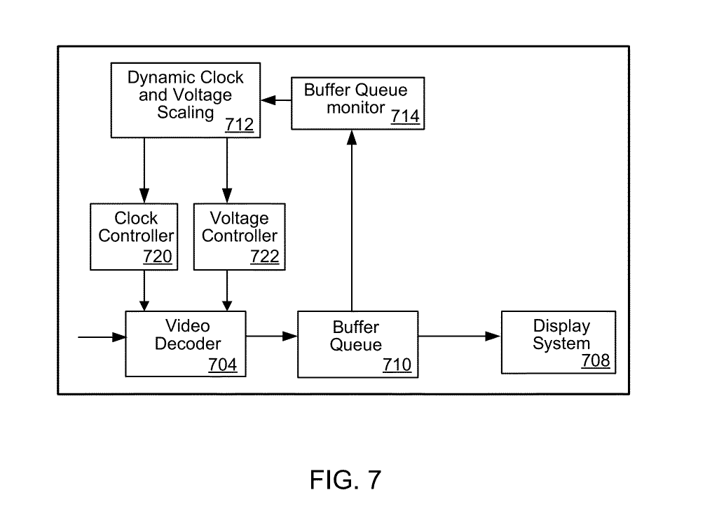

Referring to FIG. 7, shown is a block diagram depicting components that may be implemented to realize a decoding portion of the video processing system described with reference to FIG. 1. The depicted decoding portion may be realized as part of any of a variety of different types of devices including smart phones, tablets, netbooks, set top boxes, entertainment units, navigation devices, and personal digital assistants, etc. As depicted, a output buffer queue 710 is disposed between a video decoder 704 and a display system 708. In addition, an output buffer queue monitor 714 is disposed to monitor the output buffer queue 710 and communicate information to a dynamic clock and voltage-scaling (DCVS) component 712. As shown, both a clock controller 720 and a voltage controller 722 are disposed between the DCVS component 712 and the video decoder 704.

It should be recognized that the depiction of components in FIG. 7 is also a logical depiction and is not intended to depict discrete software or hardware components, and in addition, the depicted components in some instances may be separated or combined. For example, the DCVS component 712 may be adapted to provide the functionality provided by the buffer queue monitor 714 so that the DCVS component 712 both monitors the output buffer queue 710 and sends control signals to the clock controller 720 and voltage controller 722. When implemented, the depicted components may be realized by hardware, firmware, and/or hardware in connection with software. For example, the video decoder 704 may be realized by a hardware decoder (e.g., a field programmable gate array (FPGA)), a digital signal processor (DSP) decoder, or software decoder (e.g., an application processor in connection with processor-executable instructions). As a consequence, the clock frequency and or voltages that are controlled may be associated with hardware clocks, a DSP clock, and/or an application processor clock. One of ordinary skill in the art will also appreciate that there are many components that are not depicted FIG. 1 for simplicity. For example, the depicted clock controller 720 and voltage controller 722 drive a clock network (not shown) and regulators (not shown) that drive the clock frequency and voltage for the video decoder 704.

In operation, the video decoder 704 operates to decode frames that are ultimately “consumed” by the display system 708 at a regular interval (e.g., 33 or 66 Hz). To regulate data flow between the video decoder 704 and the display system 708, typically frame buffers are utilized in the output buffer queue 710, and due to decoding time variations described above, the amount of frame data that is buffered by the output buffer queue 710 may vary. From a whole end-to-end video playback system perspective, the video decoder 704 needs to make sure that decoded frames are available when the display system 708 needs them. In other words, as long as there are enough frames buffered between the video decoder 704 and the display system 708, the video decoder 704 may slow down. As a consequence, embodiments described herein adjust the clock frequency of the video decoder 704 and/or a voltage of the video decoder based upon how full the buffer queue is.

More specifically, the buffer queue monitor 714 monitors how full the output buffer queue 710 is, and in addition, the buffer queue monitor 714 provides an output, which is indicative of how full the output buffer queue 710 is, to the dynamic clock and voltage-scaling (DCVS) component 712. In turn, the DCVS component 712 provides one or more outputs to the clock controller 720 and/or the voltage controller 722, which prompt the clock controller 720 and/or the voltage controller 722 to adjust a clock frequency and/or voltage of the video decoder 704, respectively. With respect to the adjustment of the voltage, it should be recognized that the voltage adjustment may be applicable to a collection of components that includes the video decoder 704. In other words, the adjustments to the voltage level discussed herein may apply to a larger voltage domain, which the video decoder 704 is part of.

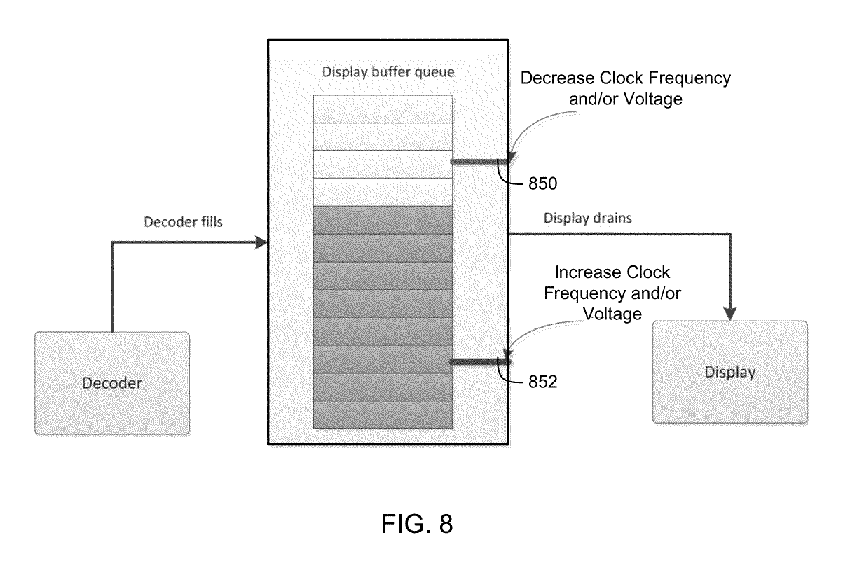

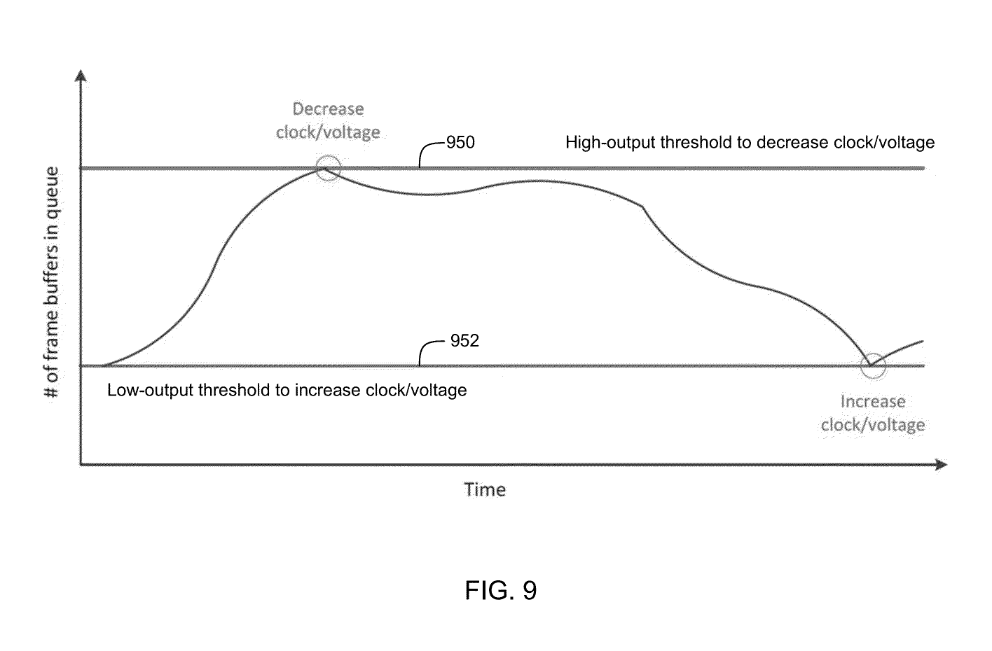

Referring next to FIG. 8, it is a schematic diagram that depicts aspects of a method that the DCVS component may perform to adjust the video decoder 704. While referring to FIG. 8, reference is also made to FIG. 9, which is a graph depicting a number of frame buffers (in the output buffer queue) versus time relative to two static thresholds 850, 852. As shown, the DCVS component 712 in this method monitors how full the output buffer queue 710 is and adjusts the video decoder 704 to lower the clock frequency (and/or supply voltage) if the out buffer fullness hits a high-output threshold 850, and the DCVS component 712 switches to higher clock (and/or supply voltage) if the level of output buffer fullness hits a low-output threshold 852. As shown in FIG. 9, the frequency and/or voltage may be set to a relatively high level until a number of frames queued hits the high-output threshold 850, and then frequency and/or voltage is decreased because the end-to-end system has enough data to display in the buffer queue. When a number of frames queued hits the low-output threshold 852, then frequency and/or voltage is increased to catch up to the display system. As opposed to prior methods that rely on performance assumptions or complexity predictions, this method (and variations thereof discussed below) is very simple and reliable.

Although the method depicted in FIG. 8 provides a clear example of how buffer fullness may be used as a basis for adjusting the video decoder 704, multiple output threshold levels may be utilized and the output threshold levels 850, 852 may be dynamically modified.

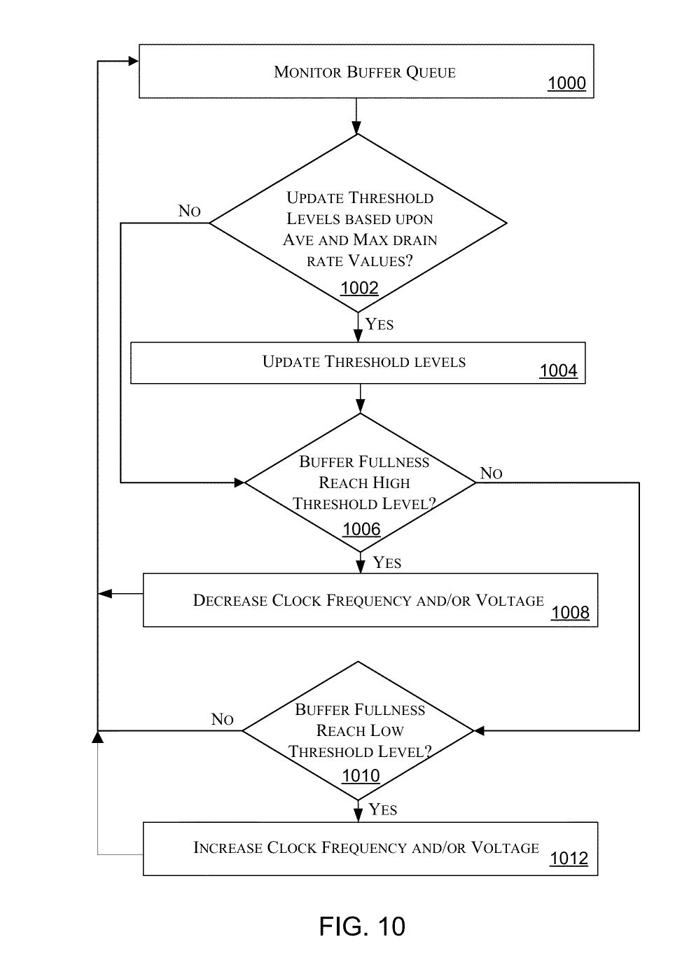

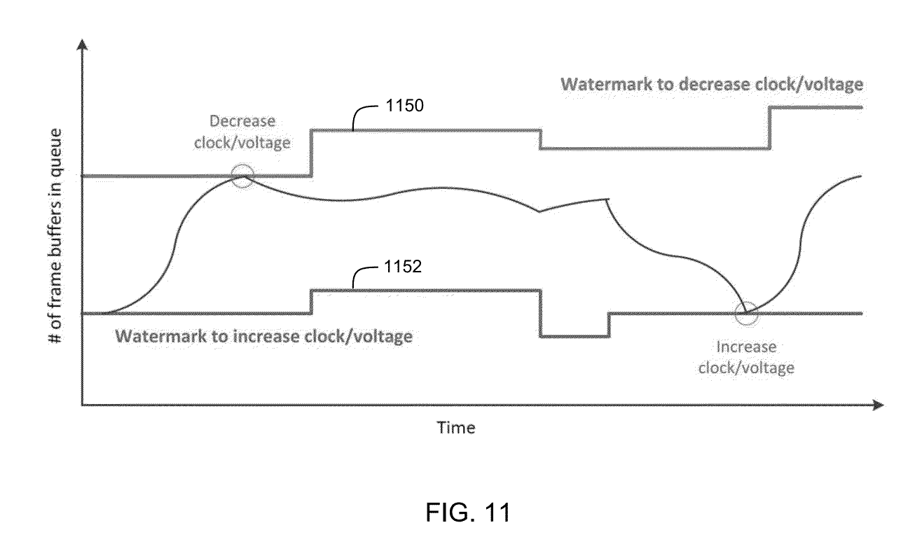

Referring to FIG. 10 for example, shown is a flowchart depicting a method that may utilize dynamic output threshold levels. While referring to FIG. 10, reference is also made to FIG. 11, which is a graph depicting a number of frame buffers in the buffer queue versus time relative to dynamic output thresholds 1150, 1152. As shown, the buffer queue monitor 710 monitors the output buffer queue 710 (Block 1000), and if the output thresholds 1150, 1152 should be updated (Block 1002), the output thresholds 1150, 1152 may be adaptively calculated sand then updated by the DCVS component 712 (Block 1004).

More specifically, one way to adapt the output thresholds 1150, 1152 is by utilizing the output buffer drain rate. The buffer drain rate is affected by the frame-complexity variation of a sequence, but frame complexity is not the only factor affecting the buffer fullness or drain rates. There may be other factors in the system that impacts the buffer fullness, or slow down/speed up the drain rate.

As shown in FIG. 10, the high-output threshold 1150 (output-threshold_{high}) may be set as a function of the average buffer drain rate and max buffer drain rate:

output-threshold_{high}=f(avg_buffer_drain_rate,max_buffer_drain_rate)

Setting the high-output threshold 1150 as a function of the average buffer drain rate effectively sets the high-output threshold 1150 to a higher level to avoid frequent fluctuations to the clock frequency and/or the voltage of the video decoder 704. The high-output threshold 1150 may be generally defined as output-threshold_{high=α*ave}_buffer_drain_rate+β*max_buffer_drain_rate+λ where α and β are tuning parameters that may be adjusted based upon observation of the effect of the clock and/or voltage scaling under the high-output threshold 1150, and λ may be derived from system requirements. For example, a minimum high-output threshold may be needed to avoid too many frequency/voltage changes to maintain system stability, and λ can be used to set the minimum value of the high-output threshold.

In general, the low-output threshold 1152 functions as a threshold to allow the number of frame buffers (in the output buffer queue 710) to catch up to the rate that the display system 708 consumes the frames; thus the low-output threshold 1152 (output-threshold_{low}) may be set as a function of the maximum buffer drain rate:

output-threshold_{low}=f(max_buffer_drain_rate).

In this way, if the DCVS component 712 observes a higher peak drain rate, then the low-output threshold 1152 may be set higher to have enough of a safeguard. The low-output threshold 1152 may generally be defined as output-threshold_{low}=δ* max_drain_rate+γ where δ may be tuning parameter that may be adjusted based upon observation of the effect of the clock and/or voltage scaling under the low-output threshold 1152, and γ may be derived from system requirements. For example, γ may be a minimum number of frames needed in the output-buffer 110.

As depicted in FIG. 10, once the output threshold levels 1150, 1152 are updated (Block 1004), the DCVS component 712 operates to decrease the clock frequency and/or voltage of the video decoder 704 if the buffer fullness reaches the high-output threshold 1150, and the DCVS component 712 increases the clock frequency and/or voltage of the video decoder 704 if the output buffer fullness reaches a low-output threshold 1152. As depicted in FIG. 11, repetitively traversing the loop depicted in FIG. 10 over time effectuates a dynamic updating to the high-output threshold 1150 and the low-output threshold 1152.

FIGS. 10 and 11 describe a specific example in which two threshold levels 1150, 1152 are used to form a single bounded region between the threshold levels, but in general, there may be more than two threshold levels 1150, 1152 so that there are multiple bounded regions wherein each bounded region is defined by a corresponding group of two of the multiple threshold levels. In addition, it is also possible that a low threshold for a group may be the same as high threshold in the next consecutive group. More specifically, when there are three voltage operating points, V0, V1, V2 (where V0<V1<V2), between V0 and V1, two thresholds may be (output_threshold_low_{—}0, output_threshold_high_{—}0), and between V1 and V2, two thresholds may be (output_threshold_low_{—}1, output_threshold_high_{—}1), and in addition, it is possible that output_threshold_high_{—}0=output_threshold_low_{—}1.

Some example implementations are discussed above, but those of skill in the art would further appreciate that the various illustrative logical blocks, modules, circuits, and algorithms described in connection with the embodiments disclosed herein may be implemented as electronic hardware, instructions stored in memory or in another processor-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of processor readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

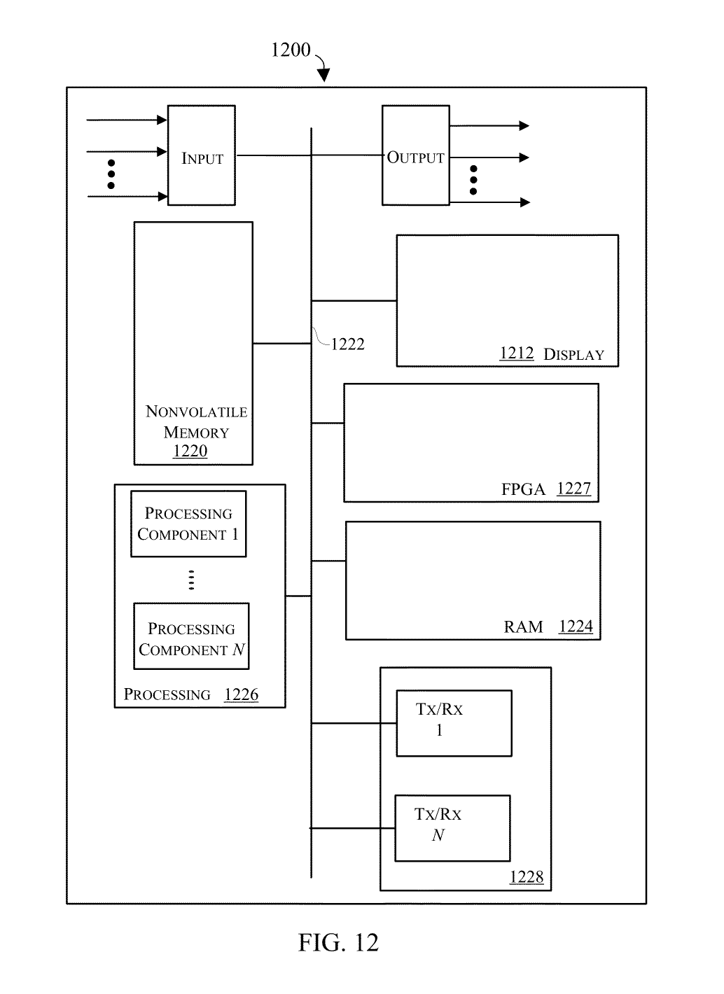

Referring to FIG. 12 for example, shown is a block diagram depicting physical components that may be utilized to realize the one or more aspects of the embodiments disclosed herein. As shown, in this embodiment a display portion 1212 and nonvolatile memory 1220 are coupled to a bus 1222 that is also coupled to random access memory (“RAM”) 1224, a processing portion (which includes N processing components) 1226, a field programmable gate array (FPGA) 1227, and a transceiver component 1228 that includes N transceivers. Although the components depicted in FIG. 12 represent physical components, FIG. 12 is not intended to be a detailed hardware diagram; thus many of the components depicted in FIG. 12 may be realized by common constructs or distributed among additional physical components. Moreover, it is contemplated that other existing and yet-to-be developed physical components and architectures may be utilized to implement the functional components described with reference to FIG. 12.

This display portion 1212 may be utilized to realize a portion of the display system 108 and it generally operates to provide a user interface for a user. The display may be realized, for example, by an LCD or AMOLED display, and in several implementations, the display is realized by a touchscreen display. In general, the nonvolatile memory 1220 is non-transitory memory that functions to store (e.g., persistently store) data and processor executable code (including executable code that is associated with effectuating the methods described herein). In some embodiments for example, the nonvolatile memory 1220 includes bootloader code, operating system code, file system code, and non-transitory processor-executable code to facilitate the execution of the methods described with reference to FIGS. 5 and 10 described further herein.

In many implementations, the nonvolatile memory 1220 is realized by flash memory (e.g., NAND or ONENAND memory), but it is contemplated that other memory types may be utilized as well. Although it may be possible to execute the code from the nonvolatile memory 1220, the executable code in the nonvolatile memory is typically loaded into RAM 1224 and executed by one or more of the N processing components in the processing portion 1226.

The N processing components in connection with RAM 1224 generally operate to execute the instructions stored in nonvolatile memory 1220 to enable clock and/or voltage scaling described herein. For example, non-transitory processor-executable instructions to effectuate the methods described with reference to FIGS. 5 and 10 may be persistently stored in nonvolatile memory 1220 and executed by the N processing components in connection with RAM 1224. As one of ordinarily skill in the art will appreciate, the processing portion 1226 may include a video processor, digital signal processor (DSP), graphics processing unit (GPU), and other processing components.

In addition, or in the alternative, the FPGA 1227 may be configured to effectuate one or more aspects of the methodologies described herein (e.g., the methods described with reference to FIGS. 5 and 10). For example, non-transitory FPGA-configuration-instructions may be persistently stored in nonvolatile memory 1220 and accessed by the FPGA 1227 (e.g., during boot up) to configure the FPGA 1227 to effectuate the functions of the DCVS components 212, 712.

The depicted transceiver component 1228 includes N transceiver chains, which may be used for communicating with external devices via wireless or wireline networks. Each of the N transceiver chains may represent a transceiver associated with a particular communication scheme (e.g., WiFi, CDMA, Bluetooth, NFC, etc.). The transceiver chains may be utilized to receive video frames that are processed (encoded or decoded) as described herein, and may be used to send video frames to another device.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for controlling a video core, the method comprising:
buffering video frames for a video encoder in an input buffer queue;
generating an indication of a fullness of the input buffer queue;
establishing a high-input threshold and a low-input threshold level for the input buffer queue;
increasing a clock frequency of the video encoder in response to the indication of the fullness reaching the high-input threshold for the input buffer queue; and
decreasing the clock frequency of the video encoder in response to the indication of the fullness reaching the low-input threshold for the input buffer queue.

2. The method of claim 1, wherein establishing a high-input threshold for the buffer queue and a low-input threshold for the buffer queue includes:
establishing the low-input threshold for the input buffer queue based upon an average buffer drain rate; and
establishing the high-input threshold for the input buffer queue based upon a maximum buffer drain rate.

3. The method of claim 1, including:
establishing more than two input thresholds for the input buffer queue.

4. The method of claim 3, wherein a single threshold is utilized as a both a low-input threshold and a high-input threshold.

5. The method of claim 1, comprising:
decoding encoded video frames with a video decoder to generate decoded video frames;
buffering the decoded video frames in an output buffer queue;
generating an indication of a fullness of the output buffer queue;
establishing a high-output threshold and a low-output threshold for the output buffer queue;
decreasing a clock frequency of the video decoder in response to the indication of the fullness reaching the high-output threshold for the output buffer queue; and
increasing the clock frequency of the video decoder in response to the indication of the fullness reaching the low-output threshold for the output buffer queue.

6. The method of claim 5, wherein establishing a high-output threshold and a low-output threshold for the buffer queue includes:
establishing the high-output threshold for the output buffer queue based upon an average buffer drain rate; and
establishing the low-output threshold for the output buffer queue based upon a maximum buffer drain rate.

7. The method of claim 5, including:
establishing more than two output thresholds for the output buffer queue.

8. The method of claim 7, wherein a single threshold is utilized as a both a low-output threshold and a high-output threshold.

9. A computing device comprising:
a video decoder to generate decoded video frames from encoded video frames;
a clock frequency controller to control a clock frequency of the video decoder;
an output buffer queue to buffer the decoded video frames;
an output buffer queue monitor to monitor the output buffer queue and generate an indication of a fullness of the output buffer queue; and
a dynamic clock and voltage scaling component to receive the indication of the fullness of the output buffer queue and provide control signals to the clock frequency controller to effectuate changes to the clock frequency based upon a fullness of the output buffer queue.

10. The computing device of claim 9, wherein the dynamic clock and voltage scaling component establishes a high-output threshold for the output buffer queue and a low-output threshold for the output buffer queue, wherein the dynamic clock and voltage scaling component decreases a clock frequency of the video decoder in response to the indication of the fullness reaching the high-output threshold for the output buffer queue, and the dynamic clock and voltage scaling component increases a clock frequency of the video decoder in response to the indication of the fullness reaching the low-output threshold for the output buffer queue.

11. The computing device of claim 10, wherein the dynamic clock and voltage scaling component is configured to:
establish the high-output threshold for the output buffer queue based upon an average buffer drain rate value; and
establish the low-output threshold for the output buffer queue based upon a maximum buffer drain rate value.

12. The computing device of claim 9, including:
an input buffer queue to buffer video frames from a frame source;
a video encoder to generate encoded video frames from the video frames;
a clock frequency controller to control a clock frequency of the video encoder; and
an input buffer queue to monitor the input buffer queue and generate an indication of a fullness of the input buffer queue;
wherein the dynamic clock and voltage scaling component is configured to receive the indication of the fullness of the input buffer queue and provides control signals to the clock frequency controller to effectuate changes to the clock frequency based upon a fullness of the input buffer queue.

13. The computing device of claim 12, wherein the dynamic clock and voltage scaling component establishes a high-input threshold for the input buffer queue and a low-input threshold for the input buffer queue, wherein the dynamic clock and voltage scaling component increases a clock frequency of the video encoder in response to the indication of the fullness reaching the high-input threshold for the input buffer queue, and the dynamic clock and voltage scaling component decreases a clock frequency of the video encoder in response to the indication of the fullness reaching the low-input threshold for the input buffer queue.

14. The computing device of claim 13, wherein the dynamic clock and voltage scaling component is configured to:
establish the low-input threshold for the input buffer queue based upon an average buffer drain rate; and
establish the high-input threshold for the input buffer queue based upon a maximum buffer drain rate.

15. A non-transitory, tangible processor readable storage medium, encoded with processor readable instructions to perform a method for processing video frames, the method comprising:
decoding video frames with a video decoder to generate decoded video frames;
buffering the decoded video frames in an output buffer queue;
generating an indication of a fullness of the output buffer queue;
establishing a high-output threshold and a low-output threshold for the output buffer queue;
decreasing a clock frequency of the video decoder in response to the indication of the fullness reaching the high-output threshold for the output buffer queue; and
increasing the clock frequency of the video decoder in response to the indication of the fullness reaching the low-output threshold for the output buffer queue.

16. The non-transitory, tangible processor readable storage medium of claim 15, wherein establishing a high-output threshold for the output buffer queue and a low-output threshold level for the output buffer queue includes:
establishing the high-output threshold for the output buffer queue based upon an average buffer drain rate; and
establishing the low-output threshold for the output buffer queue based upon a maximum buffer drain rate.

17. The non-transitory, tangible processor readable storage medium of claim 15, the method including:
establishing more than two output thresholds for the output buffer queue;
wherein a single threshold is utilized as a both a low-output threshold and a high-output threshold.

18. The non-transitory, tangible processor readable storage medium of claim 15, the method including:
buffering video frames in an input buffer queue;
encoding the video frames with a video encoder to generate encoded video frames;
generating an indication of a fullness of the input buffer queue;
establishing a high-input threshold and a low-input threshold level for the input buffer queue;
increasing a clock frequency of the video encoder in response to the indication of the fullness reaching the high-input threshold for the input buffer queue; and
decreasing a clock frequency of the video decoder in response to the indication of the fullness reaching the low-input threshold for the input buffer queue.

19. The non-transitory, tangible processor readable storage medium of claim 18, wherein establishing a high-input threshold for the buffer queue and a low-input threshold for the buffer queue includes:
establishing the low-input threshold for the input buffer queue based upon an average buffer drain rate; and
establishing the high-input threshold for the input buffer queue based upon a maximum buffer drain rate.

20. The non-transitory, tangible processor readable storage medium of claim 19, the method including:
establishing more than two input thresholds for the input buffer queue;
wherein a single threshold is utilized as a both a low-input threshold and a high-input threshold.
